(19) United States
(12) Patent Application Publication
(10) Pub. No.: US 2014/0060474 A1
(43) Pub. Date: Mar. 6, 2014

(54) Engine Balancer

(71) Applicant: Hitachi Automotive Systems, Ltd., Hitachinaka-shi (JP)

(72) Inventors: Kosaku OHNO, Mito (JP); Takashi HIRANO, Novi, MI (US); Tamotsu TODO, Atsugi-shi (JP)

(73) Assignee: Hitachi Automotive Systems, Ltd., Hitachinaka-shi (JP)

(21) Appl. No.: 13/972,661

(22) Filed: Aug. 21, 2013

(30) Foreign Application Priority Data
Aug. 31, 2012 (JP) 2012-190807

(51) Int. Cl. F16C 3/20

(52) U.S. Cl. CPC F16C 3/20
USPC 123/192.2

(57) ABSTRACT

An engine balancer including a driving gear, a driving shaft, a driven gear, and a gear pair formed by interlocking the driving gear with the driven gear, wherein the driving gear is engaged with the driven gear, and the engine balancer further includes a fixing member to elastically fix the driving gear onto the driving shaft.

### BACKGROUND OF THE INVENTION

The present invention relates to a vibration damping unit to reduce vibration and noise of an engine balancer, and in particular, to a gear fixing method of damping vibration of an engine balancer including parallel-axis gears such as a helical gear.

Most motors mounted on cars and the like are reciprocating engines. In engines such as a 4-cylinder diesel engine having relatively a smaller number of cylinders and strong explosion force, the engine is vibrated in the cycle of explosion to impose an uncomfortable feeling on the car users in the car. To eliminate such uncomfortable feeling, a vibration damping unit called a balancer is installed in a bottom section of the engine depending on cases.

In the balancer, a counterweight is disposed at an eccentric position on a rotation shaft such that the vibration is cancelled by force of inertia produced by rotating the rotation shaft. For example, in a 4-stroke, 4-cylinder engine, two power strokes take place per rotation of an engine power shaft (crankshaft). Hence, by increasing the rotation speed of the crankshaft, for example, by a gear such that the counterweight shaft rotates at a rotation speed which is twice the rotation speed of the crankshaft, it is possible to damp the engine vibration. To suppress the whirling vibration of the counterweight shaft, the balancer includes two counterweight shafts disposed in parallel to each other in most cases. When these counterweight shafts set to an in-phase state respectively rotate in mutually opposite directions, there is obtained force of inertia in a normal direction with respect to the plane defined by centerlines of the counterweight shafts. To set counterweight shafts to an in-phase state, helical gears less causing the mesh vibration are employed.

Torque required to rotate each counterweight shaft is inertia torque about the shaft associated with viscous friction loss and viscous fluid loss as well as acceleration and deceleration. The torque is basically smaller in magnitude when compared with power required to drive the car. On the other hand, at each explosion in the engine, a large variation takes place in torque in the forward and reverse directions. Hence, when the variation in the reverse-directional torque is larger than torque of the counterweight rotation, the tooth surfaces of the gears transmitting the load move apart from each other and collide with the surface opposite to the load surface, to cause so-called rattle noise. Load of shock produced through the collision propagates from the bearing via the bearing box and the engine mount to the compartment of the car to vibrate walls of the compartment. This is recognized as noise by the car user depending on cases.

In the prior art, various ideas have been proposed to suppress the rattle noise. For example, the backlash as a gap between the tooth faces of the gears on the side opposite to the load side is reduced to prevent increase in force of inertia at collision of the tooth surfaces. Or, scissors gears are employed, specifically, the gear is split into two sections in the axial direction such that by pre-pushing the gear by use of a spring to interpose associated teeth, the tooth surfaces are prevented from moving away from each other. However, when the attaching position of the balancer is changed from the conventional position depending on various engine systems of today, the assembly precision of gears is lowered due to influences of thermal deformation and deviation in work dimensions. This resultantly makes it difficult to retain appropriate precision of the backlash. Also, due to a severe requirement to lower the cost for the product, it is difficult to employ expensive scissors gears having complex structure.

To overcome the difficulty, for example, JP-A-2011-169269 proposes a configuration in which the gear is divided into an inner member and an outer member and a vibration reducing member is disposed therebetween to increase inner frictional resistance and to damp vibration. JP-A-2011-169269 describes that due to the configuration, the inner frictional resistance is increased and the vibration is damped by the vibration reducing member, to thereby prevent the rattle noise.

### SUMMARY OF THE INVENTION

In a device such as a balancer in which vibrational torque from gears is larger in amplitude than the static torque, when the backlash is large, the interval through which the tooth surface travels for the collision is long and tooth-hit shock becomes stronger. To mitigate this phenomenon, it is required to dispose a shock absorbing element between teeth and the gear.

On the other hand, in the conventional configuration described above, the inner and outer members of the gear are completely separated from each other and a vibration damping member having relatively low rigidity is arranged between the inner and outer members. It is hence not easy to keep the precision of coaxial state with respect to the tooth face of the gear and the gear shaft. As a result, the center distance variation and the irregular or one-sided contact take place in the gear, and this increases not only the whine noise or rattle noise of gears, but due to local increase in stress associated with the interlocking, it is likely that the tooth face is damaged. When a helical gear is employed as the gear, fluctuating load appears in the axial direction in association with the variation in torque at the interlocking position. Hence, it may occur that the outer member falls out or is removed.

It is therefore an object of the present invention to provide a highly reliable gear device wherein in an apparatus in which the vibrational torque transmitted by gears is higher in amplitude than the static torque, when the backlash is allowed to be relatively large, the tooth-hit shock at collision of the tooth surface is buffered and the precision of the coaxial state between the gear and the gear shaft is retained to reduce the whine noise and the rattle noise of the gear, and the tooth surface damage due to the one-sided contact and the like is prevented and the removal of the gear due to the fluctuating load in the axial direction is also prevented.

To achieve the object, the configuration of, for example, the invention as set forth in the claims will be adopted.

Specifically, there is provided a gear pair including a driving gear, a driving shaft, and a driven gear, the gear pair being formed by interlocking the driving gear with the driven gear, wherein the driving gear is engaged with the driven gear, the gear pair further including a fixing member to elastically fix the driving gear onto the driving shaft.

Or, there is provided an engine balancer comprising a driving gear, a driving shaft, a driven gear, and a gear pair formed by interlocking the driving gear 3 with the driven gear, wherein the driving gear is fixed onto the driven gear, a transmission gear is engaged with the driving shaft, and the driving gear is elastically coupled with the transmission gear by use of a fixing member.

Due to the configuration, even when the backlash is allowed to be relatively elongated, the tooth-hit shock at collision of the tooth face is buffered through the friction damping which takes place between engaging surfaces of the gear and the gear shaft, to minimize the rattle noise. Since the gear and the gear shaft is engaged with each other, the precision of coaxial state is kept high, and the rattle noise is kept reduced and there occurs no tooth-face damage caused by the one-sided contact or the like. Due to the fixing member to elastically fix both gears to each other, there occurs no removal of the gear caused by the fluctuating load in the axial direction. It is hence possible to provide a still and highly reliable gear device.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of a configuration of an engine balancer in a first embodiment of the present invention;

FIG. 2 is a diagram showing an example of a configuration of a gear fixing member of the present invention;

FIG. 3 is a diagram showing an example of another configuration of a gear fixing member of the present invention;

FIG. 4 is a diagram showing an example of a still another configuration of a gear fixing member of the present invention; and

FIG. 5 is a diagram showing an example of a configuration of an engine balancer in a second embodiment of the present invention

### DESCRIPTION OF THE EMBODIMENTS

Next, description will be given of embodiments by referring to the drawings.

### Embodiment 1

For the present embodiment, description will be given of a device configuration including, in addition to the gear to synchronize the counterweights, a transmission gear to transmit power.

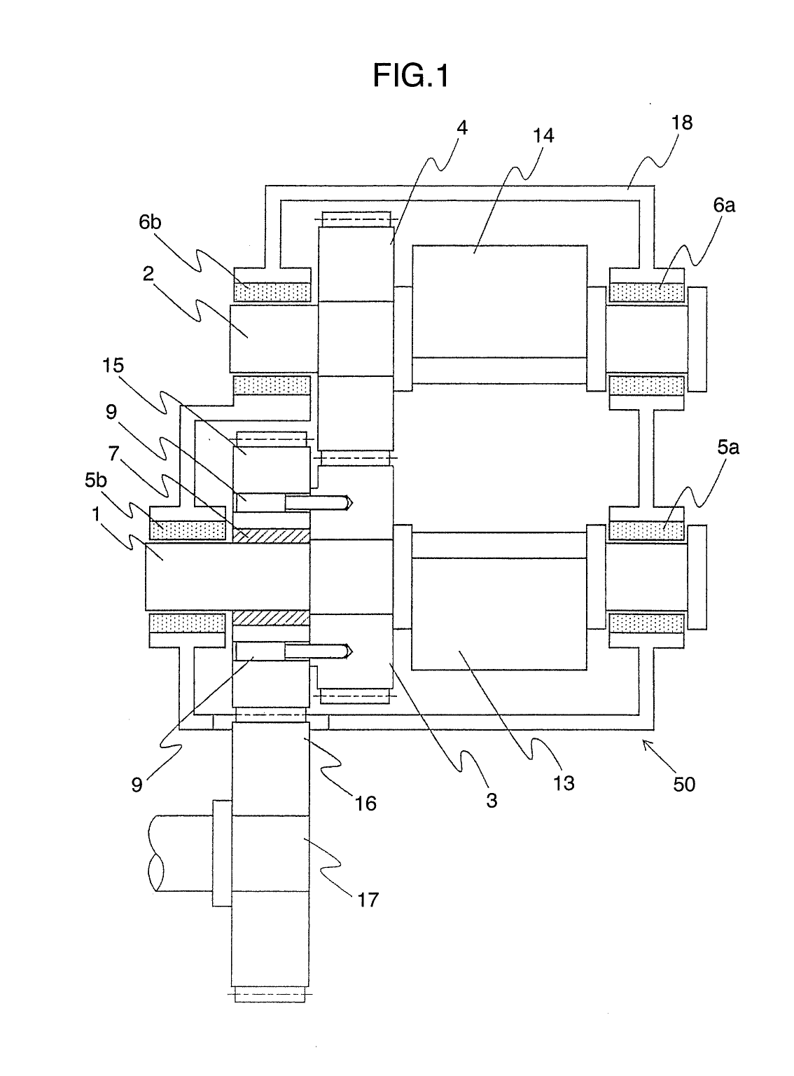

FIG. 1 shows a configuration example of an engine balancer according to the present embodiment. The balancer 50 is attached onto a bottom section of an engine block, not shown, and power obtained from a crank shaft, not shown, is transmitted to an input gear 16 disposed coaxially on an input shaft 17. On the other hand, in the balancer 50, a driving shaft 1 engages with a driving gear 3 and is pivotally supported by driving gear bearings 5a and 5b, and a driven shaft 2 engages with a driven gear 4 and is pivotally supported by driven gear bearings 6a and 6b. On the respective shafts, a driving shaft counterweight 13 and a driven shaft counterweight 14 are installed at positions apart from the center of rotation and the driven shaft 2 interlocks with the driven gear 4, to thereby configure the balancer. Further, on the driving shaft 1, a transmission gear 15 is engaged via a sleeve 7, and the driving gear 1 is coupled with the transmission gear 15 by fixing pins 9. The transmission gear 15 is engaged with the input gear 16. The input gear 16, the transmission gear 15, the driving gear 3, and the driven gear 4 are helical gears. To establish synchronization between the driving shaft counterweight 13 and the driven shaft counterweight 14, the driving gear 3 and the driven gear 4 are substantially equal in the number of teeth to each other. The driving gear 3 is shrink-fitted onto the driving shaft 1 and the driven gear 4 is shrink-fitted onto the driven shaft 2. Each gear is substantially integrally formed with the associated shaft. The driving shaft 1 is pushed with pressure onto the sleeve 7, and the sleeve 7 is pushed with pressure onto the transmission gear 15. While the backlash is small between the driving gear 3 and the driven gear 4, the backlash is large between the input gear 16 and the transmission gear 15. The fixing pints 9 are produced by using alloy metal having sufficient hardness and toughness and are pushed with high pressure respectively into the driving gear 3 and the transmission gear 15, which prevents removal of the transmission gear 15.

In the configuration, when the input gear 16 rotates in association with operation of a crank shaft, not shown, the transmission gear 15 engaged with the input gear 16 starts rotation thereof. Then, the driving gear 3 and the driving shaft 1 which are coaxially disposed with respect to the transmission gear 15 rotates to resultantly cause rotation of the driving shaft counterweight 13. Since the driven gear 4 interlocked with the driving gear 3 rotates, the driven shaft 2 and the driven shaft counterweight 14 which are coaxially disposed with respect thereto starts rotation. The explosion cycle of the engine is synchronized with the rotation of the driving shaft counterweight 13 and the driven shaft counterweight 14, and these counterweights 13 and 14 rotate in mutually different directions. Hence, the balancer 50 does not cause the whirling vibration, to mitigate the explosion vibration of the engine.

In a situation wherein a speed fluctuation is inputted to the input gear 16 in association with the explosion in the engine, since the backlash is large between the input gear 16 and the transmission gear 15, strong tooth-hit shock takes place on tooth surfaces thereof. On the other hand, since the tortional rigidity is relatively low between the transmission gear 15 and the driving gear 3, relative displacement takes place primarily in the tortional direction between the gears 15 and 3. The relative displacement is not so large to cause macroscopic slippage between the driving shaft 1 and the sleeve 7 and between the sleeve 7 and the transmission gear 15. That is, the relative displacement has magnitude at most to cause slippage in a part of the contact region. Due to attenuation of friction therebetween, the tooth-hit shock is buffered, and force of shock transmitted to the driving gear 3 is reduced. As a result, the force of shock transmitted from the driving shaft 1 to the driving gear shaft bearings 5a and 5b is also reduced. This minimizes the rattle noise propagated via the engine mount to the car compartment. Further, since the input shaft 1 is pushed with pressure into the sleeve 7 and the sleeve 7 is also pushed with pressure into the transmission gear 15, the precision of coaxial state is kept high therebetween. Hence, it does not occur that eccentricity takes place in the transmission gear 1 to produce noise and the transmission gear 1 resultantly makes the one-sided contact with the input gear 16 to damage the tooth surface.

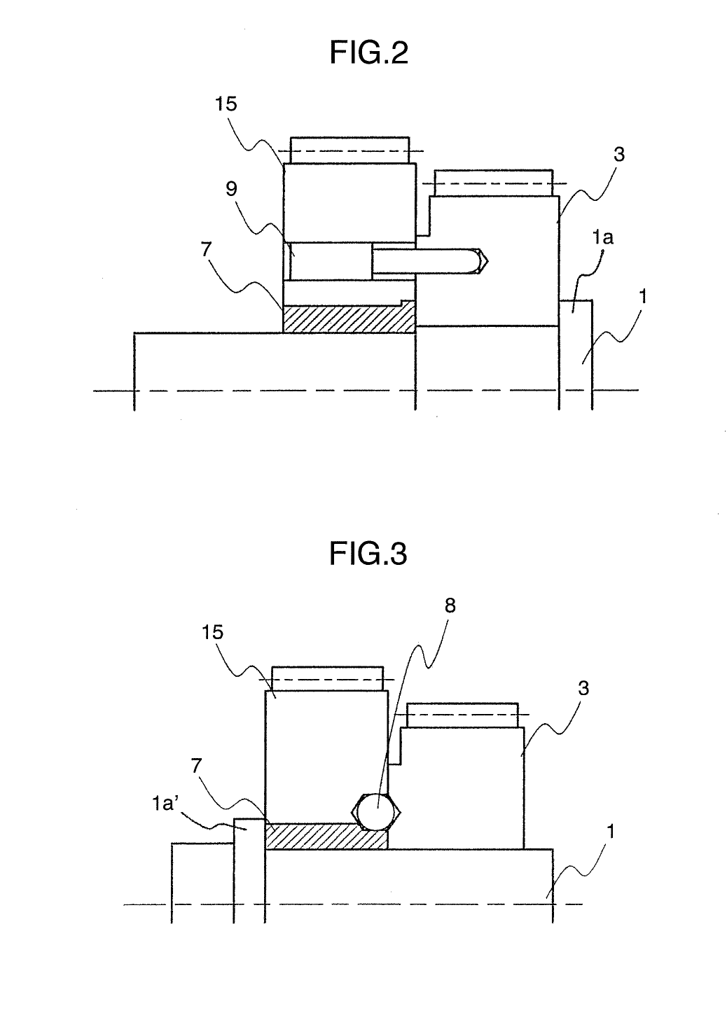

FIG. 2 shows a magnified view of a coupling section between the transmission gear 15 and the driving gear 3 of the present embodiment. The driving gear 3 is pushed against a stepped section 1a of the driving shaft 1 to be shrink-fitted thereonto, to be substantially integrally formed with the driving shaft 1. On the other hand, for the sleeve 7 pushed with pressure onto the driving shaft 1 and the transmission gear 15 pushed with pressure onto the sleeve 7, relative displacement is microscopically allowed. Hence, due to attenuation of friction in the engaging section, the force of shock is attenuated. The transmission gear 15 is attached onto the fix pin 9 with high pressure and the fix pin 9 is attached onto the driving gear 3 with high pressure. Hence, there exists sufficient resistive force against removal associated with axial-directional load in the gear interlocking section. On the other hand, flectual rigidity is adjusted to allow slight, relative displacement between the transmission gear 15 and the driving shaft 1. Since the flectual rigidity is relatively low, the assembly is possible even when the fixing hole is slightly shifted from its optimal position. In the sleeve 7, a projection is disposed in the outer circumference of the edge surface on the side of the contact with the driving gear 3. In the engaging section of the transmission gear 15, a depression is disposed to interlock with the projection of the sleeve 7. Hence, the sleeve 7 is not removed alone. It is favorable to produce the sleeve 7 by use of a material such as bronze having high self-lubricating ability. The attenuation effect is improved by concentrically arranging a plurality of sleeves 7. However, the sleeve 7 may be dispensed with to obtain an inexpensive configuration.

FIG. 3 shows a configuration example in which a stepped section 1a′ of the driving shaft 1 is on the side of the transmission gear 15. The sleeve 7 and the transmission gear 15 are pushed against the stepped section 1a′ of the driving shaft 1 to be pushed thereonto with pressure. The driving gear 3 is shrink-fitted in a state in which the sleeve 7 and the transmission gear 15 are interposed between the driving gear 3 and the stepped section 1a′. Due to the configuration, the fixing pin may be dispensed with to lower the production cost. In the color 7, the transmission gear 15, and the driving gear 3, small holes are bored on the respective side surfaces making contact with each other, and a steel ball 8 is inserted in the space formed by the holes. The steel ball 8 linearly makes contact with the small holes. Hence, contact rigidity is adjustable by appropriately changing the diameter of the steel ball 8. It is accordingly possible to set the tortional rigidity between the transmission gear 15 and the driving gear 3 to an optimal value.

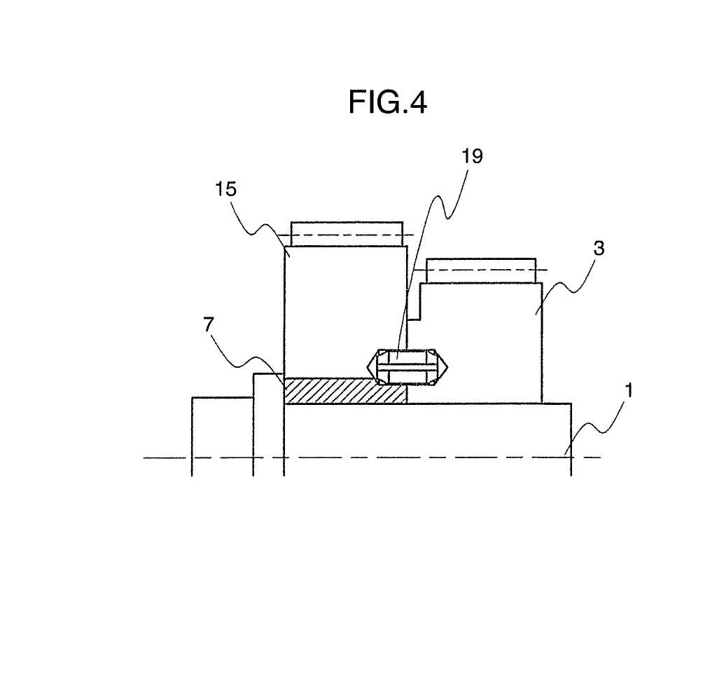

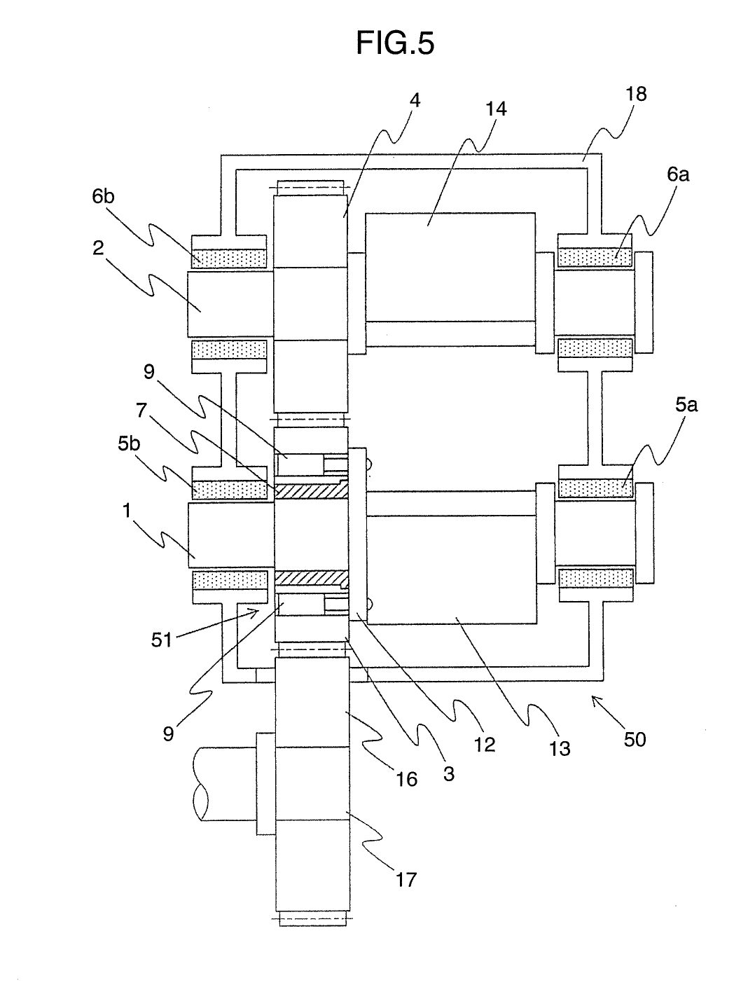

FIG. 4 shows a configuration example obtained by replacing the steel ball 8 of FIG. 3 by a spring pin 19. Due to the configuration, it is possible to further reduce the tortional rigidity between the transmission gear 15 and the driving gear 3. In this situation, there may be employed a configuration in which by reducing the interference between the driving shaft 1 and the sleeve 7, the relative displacement is allowed also in a macroscopic manner for the driving shaft 1, the sleeve 7, and the transmission gear 15. In this case, further appropriate vibration damping effect is obtained, for example, by forming the sleeve 7 using sintered alloy, by increasing the self-lubricating ability through impregnation using lubricating oil, and/or by dispersing solid lubricating agent, although it is required to prevention abrasion abrasion in the engaging section.

### Embodiment 2

FIG. 5 shows a configuration example of an engine balancer of the present embodiment in which the transmission gear is dispensed with. The input gear 16 is directly interlocked with the driving gear 3. The driving shaft 1 is pushed with pressure into the sleeve 7 and the sleeve 7 is also pushed with pressure into the driving gear 3. The fixing pins 9 are inserted with high pressure into small holes disposed in a flange 12 integrally formed on the input shaft 1 and the driving gear 3, to prevent separation therebetween. Since the other configurations and operations are substantially equal to those of the first embodiment, description thereof will be avoided. Due to the configuration, one gear may be dispensed with, and it is possible to lower the system cost and to reduce the engine balancer in size.

It should be further understood by those skilled in the art that although the foregoing description has been made on embodiments of the invention, the invention is not limited thereto and various changes and modifications may be made without departing from the spirit of the invention and the scope of the appended claims.

1. An engine balancer comprising:
a driving gear;
a driving shaft;
a driven gear, and
a gear pair formed by interlocking the driving gear with the driven gear, wherein
the driving gear is engaged with the driven gear,
the engine balancer further comprising a fixing member to elastically fix the driving gear onto the driving shaft.

2. An engine balancer comprising:
a driving gear;
a driving shaft;
a driven gear, and
a gear pair formed by interlocking the driving gear with the driven gear, wherein
the driving gear is fixed onto the driven gear,
a transmission gear is engaged with the driving shaft, and
the driving gear is elastically coupled with the transmission gear by use of a fixing member.

3. The engine balancer according to claim 1, wherein the fixing member is in the contour of a pin.

4. The engine balancer according to claim 2, wherein the fixing member is in the contour of a pin.

5. The engine balancer according to claim 1, wherein the fixing member is a steel ball.

6. The engine balancer according to claim 2, wherein the fixing member is a steel ball.

7. The engine balancer according to claim 1, wherein the fixing member is a spring pin.

8. The engine balancer according to claim 2, wherein the fixing member is a spring pin.
